(19) United States
(12) Patent Application Publication
(10) Pub. No.: US 2010/0092751 A1
(43) Pub. Date: Apr. 15, 2010

(54) FIBER COMPOSITE COMPRISING A METALLIC MATRIX, AND METHOD FOR THE PRODUCTION THEREOF

(75) Inventors: Martin Englhart, Schoenau (DE); Hans Krug, Keltern (DE); Dietrich Jonke, Haar (DE); Helmut Piringer, Baldham (DE)

Correspondence Address: DARBY & DARBY P.C., P.O. BOX 770, Church Street Station, New York, NY, 10008-0770, US

(73) Assignee: AIRBUS SAS

(21) Appl. No.: 12/524,408

(22) PCT Filed: Jan. 12, 2008
(86) PCT No.: PCT/DE08/00055

§ 371 Date: Dec. 11, 2009

(30) Foreign Application Priority Data
Jan. 24, 2007 (DE) 10 2007 004 531.1

(51) Int. Cl. B32B 15/14; B05D 1/12; B05D 1/36; C23C 4/08

(52) U.S. Cl. 428/220; 427/180; 427/202; 427/455; 428/293.1

(57) ABSTRACT

A fibre composite material having a metal matrix includes a fibre material having individual fibres. A metal coating includes a metallization layer disposed on the individual fibres so as to surround the fibres. A metal final layer is disposed on the metallization layer, wherein the metal coating forms the metal matrix

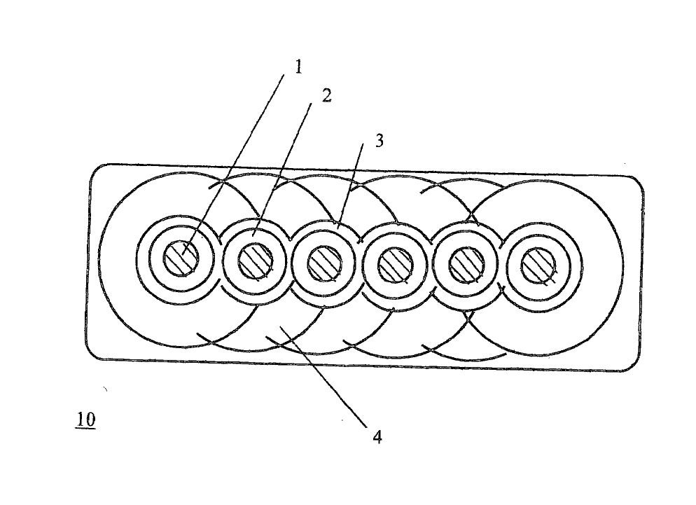

This is a U.S. National Phase Application under 35 U.S.C. §171 of International Application No. PCT/DE2008/000055, filed on Jan. 12, 2008, which claims priority to German Patent Application No. DE 10 2007 004 531.1, filed on Jan. 24, 2007. The International Application was published in German on Jul. 31, 2008 as WO 2008/089722 under PCT article 21(2).

The invention relates to a fibre composite material with metal matrix and a method for the production of such a material.

### BACKGROUND

Fibre composite materials of plastic are known, in which, for example, glass, carbon or aramide fibres are embedded in a synthetic resin such as epoxy, polyester or vinyl ester resin or a similar synthetic resin. In this case, the synthetic resin forms a matrix which typically encloses fibres arranged in the form of a scrim, woven fabric or braided fabric and connects them together. A problem with such conventional plastic fibre composite materials is the circumstance that in the event of damage, possibly in vehicles such as land, water or in particular, aircraft, they are combustible and susceptible to splintering with sharp-edged, spiky fragments.

In addition, composite materials with a metal matrix are known (also called metal matrix composite materials) which, however, are technically complex to be produce since original or moulded articles are used which additionally brings with it the disadvantage that the geometrical configurational freedom of the semi-finished product or component to be produced is severely restricted. Furthermore, the metal matrix composite materials used hitherto are mostly heavy, which is particularly disadvantage in aerospace technology. In addition, they have the shortcoming that no non-positive connection is produced between fibres and metal.

With PVD/CVD methods, for example, fibres can be coated all-embracingly but only with a relatively high expenditure on apparatus at the same time as long coating times. For a layer thickness of, for example, 0.1 mm, a period of several hours up to a few days is required in one PVD/CVD method depending on the material. Consequently, a plurality of different materials can indeed by deposited by the PVD/CVD method but only with above-average long process times. In addition, the component size to be coated is limited by the dimensioning of the required vacuum vessel.

Known from U.S. Pat. No. 5,846,288 is a method for producing an electrically conductive material which, for example, can be used for producing pressed or sintered conducting strips or bars, in which granular particles produced in a solution of silver salts of tin oxide are coated.

### SUMMARY OF THE INVENTION

An aspect of the present invention is to provide a metal matrix fibre composite material which has a high strength, which is not combustible and is not susceptible to fracture, as well as to provide a method for producing such a material which can be carried out simply and rapidly.

In an embodiment of the present invention, a fibre composite material with a metal matrix is provided including a fibre material having individual fibres and a metal coating applied thereto, which forms the metal matrix, wherein the metal coating comprises a metallization layer surrounding the fibres and a metal final layer applied for its part to the metallization layer.

The metal coating can comprise an additional metal adhesive layer located between the metallization layer and the metal final layer, which is advantageous for improving the adhesion in the case of thermally sprayed final layers.

The metallization layer can have a thickness of 0.5 μm to 0.5 mm

The metal final layer can have a thickness of 2 μm to 20 mm, or preferably 20 μm to 2 mm.

The additional metal adhesive layer can have a thickness of 2 μm to 1 mm or 20 μm to 200 μm.

The fibres can be glass, carbon and/or aramide fibres. Fibres of electrically non-conductive material are particularly preferably used.

The metallization layer and/or the additional metal adhesive layer can contain copper and/or nickel.

The metal final layer typically includes a light metal (e.g. aluminium), which is particularly advantageous for weight reasons. However, copper-based materials or heavy metals can also be used.

The fibre material can be formed by a scrim (e.g. fibre nonwoven), woven fabric, nonwoven or braided fabric of fibres.

According to one embodiment of the invention, the fibres of the scrim, woven fabric or braided fabric as such are coated with the metallization layer or with the metallization layer and the additional metal adhesive layer and that the scrim, woven fabric or braided fabric is coated overall with the final layer. Equally however, it is possible to start from an already prefabricated fibre scrim, woven fabric or braided fabric which is additionally provided in its entirety with a metallization layer and optionally an adhesive layer before the final layer is then applied.

The metal matrix fibre composite material according to the invention can be used in aircraft construction (e.g. wings, rudders etc.), in automobile racing (e.g. spoilers, trim, substructure etc.), in missiles, sports equipment and many other areas.

The invention also provides a method for producing a fibre composite material with metal matrix. According to the invention, it is provided that a metal coating forming the metal matrix is applied to a fibre material consisting of individual fibres, wherein the metal coating is formed by a metallization layer surrounding the fibres and a metal final layer applied to the metallization layer.

In addition, the metal coating can contain a metal adhesive layer applied between the metallization layer and the metal final layer which is particularly advantageous when the final layer is applied by thermal spraying.

The metallization layer can be applied chemically/reactively or by thermal spraying.

The metal final layer can be applied galvanically or by thermal spraying. An application by thermal spraying is particularly simple, rapid and cost-effective and allows a high flexibility with regard to the desired geometry.

The additional metal adhesive layer can also be applied galvanically or by thermal spraying.

The fibres forming the fibre material are, for example, glass, carbon and/or aramide fibres. Particular advantages are obtained, however, if fibres of electrically nonconductive material are used, which are made conductive by the metallization layer described above.

The metallization layer and/or the additional metal adhesive layer can be formed by copper and/or nickel.

The metal final layer typically includes a light metal, (e.g. aluminium), but can also be formed from a copper-based alloy or a heavy metal.

The fibre material can be formed by a scrim, woven fabric or braided fabric of the fibres.

The fibres of the scrim, woven fabric or braided fabric as such can be coated with the metallization layer or with the metallization layer and the additional metal adhesive layer and the scrim, woven fabric or braided fabric can be coated overall with the final layer. Equally, it is possible that the fibre scrim, woven fabric or braided fabric is coated in its entirety with the metallization layer and optionally the adhesive layer in such a manner that the fibres are coated all-embracingly and that the final layer is then applied, preferably by thermal spraying.

The invention particularly has the advantage that a fibre composite material with metal matrix is provided in which the fibres are connected non-positively to the metal matrix, in particular the metallization layer. This is not the case in previous methods and metal matrix composite materials.

### BRIEF DESCRIPTION OF THE DRAWINGS

An exemplary embodiment of the invention will be explained hereinafter with reference to the drawing.

The (single) FIGURE shows in a schematic enlarged cross-section view a section through the fibre composite material with metal matrix according one exemplary embodiment of the invention.

### DETAILED DESCRIPTION

The fibre composite material shown in the FIGURE, which is designated overall with the reference numeral 10, comprises a metal matrix which binds and surrounds a fibre material. The fibre material includes fibres 1 shown very schematically in the FIGURE, which can be formed, for example, by electrically conductive glass fibres or, for example, also by carbon or aramide fibres. Located on the fibres 1 is a metal conducting layer which is subsequently also designated as metallization layer 2, on which a metal adhesive layer 3 can in turn be deposited. The metallization layer 2 and the metal adhesive layer 3 are each applied to the individual fibres 1 which are processed to form a woven grid in the exemplary embodiment shown. The metal final layer 4, on the other hand, is applied in its entirety to the fibre woven fabric. Instead of providing a metal adhesive layer 3, the metal final layer 4 can also be applied directly to the metallization layer 2; in this case, merely the metallization layer 2 is located on the individual fibres 1, which are then processed, for example, to form a fibre woven fabric to which the metal final layer 4 is then applied in its entirety. Likewise, a finished fibre material (e.g. in the form of a fibre scrim semi-finished product or a woven grid) can be taken as the starting point, which is initially provided in its entirety with the metallization layer 2 in such a manner that the individual fibres 1 of the fibre material are each surrounded or enclosed all-embracingly by the metallization layer 2. An adhesive layer 3 can then optionally be applied to the metallization layer 2 in order to then apply the final layer 4, e.g. by thermal spraying.

The fibres 1 must firstly be pre-treated in order that they can be coated with excellent bonding strength, particularly if they consist of an electrically non-conducting material (e.g. glass fibres). According to the exemplary embodiment described here, the application of the metal final layer 4 can take place galvanically or by thermal spraying. For a galvanic application of the final layer 4, however, the surface of the fibres 1 must be or must be made electrically conducting. In a first step, the fibres 1 are therefore provided with the said metal conducting layer or metallization layer 2. The metallization 2 can be applied, for example, reductively/chemically or by thermal spraying.

Alternatively, the metal final layer 4 can be applied, for example, by thermal spraying. In this case, a previous application of a metallization and/or adhesive layer is also useful, which ensures intensive bonding of the metal final layer 4 to the fibres 1. The additional metal adhesive layer 3 can be applied, for example, galvanically or by means of thermal spraying. The metallization layer 2 or the metallization layer 2 and the metal adhesive layer 3 thus form the base for the thermally sprayed metal final layer 4.

According to one modification, the metallization layer 2 can also be applied to the individual fibres 1 whilst the additional metal adhesive layer 3 is applied to the fibre material formed by the fibres 1, whereupon the metal final layer 4 is then applied again.

Equally, as has already been described previously, a prefabricated (e.g. commercially available) fibre material can be taken as the starting point, which is provided with the metallization layer 2 in a first step. In this case, care should be taken that the individual fibres 1 are each enclosed by the metallization layer 2.

The metallization layer 2 can typically have a thickness of 0.5 μm to 0.5 mm, without the thickness, however, being restricted to this range. The additional metal adhesive layer 3 can have a thickness of 2 μm to 1 mm, in particular of 20 μm to 200 μm without, however, being restricted to this range. The metal final layer 4 can finally have a very different thickness, depending on the area of application between 2 μm and 20 mm, preferably between 20 μm and 2 mm

The metal conducting layer or metallization layer 2 can contain any metals suitable for this purpose or be formed by this (e.g. copper and/or nickel). The metal final layer 4 can likewise contain any suitable metals or be formed by these. The final layer 4 typically includes light metals (e.g. aluminium), copper-based materials or heavy metals.

The additional adhesive layer 3 applied galvanically or by thermal spraying can also contain copper and/or nickel and/or aluminium or another suitable metal or be formed by this.

It is particularly advantageous if a non-positive connection of the individual fibres to the metal, in particular the metallization layers, is produced. Due to the shrinkage of metals applied in liquid form, many microgaps are formed between the fibre and the metal.

### EXAMPLE

An exemplary embodiment of a metal fibre composite material can be produced as follows:
Degreasing a woven grid formed from glass fibres 1 in an alkaline, aqueous boiling degreasing, followed by thorough rinsing in demineralised water;
Chemical (electroless) metallization (e.g. chemical copper or chemical nickel) of the degreased glass fibre woven grid to produce a thin electrically conductive cladding of the hitherto electrically non-conducting fibres 1, as well as thorough rinsing;
galvanic reinforcement of the fibres 1 thinly coated with the conductive layer or metallization layer 2 to a layer thickness of, for example, 150 μm (e.g. nickel bath, current density 2-3 A/dm²), to form an additional metal adhesive layer 3 as well as again thorough rinsing and drying of the glass fibre woven grid;
gentle blasting of the galvanised (nickel-plated) surface with corundum (grain size, for example, 0 to 100 μm) on both sides in an injector shot-blasting system in order to thereby roughen the surface;

coating of the roughened surface on both sides by means of electric arc spraying with a light metal (e.g. aluminium). The electric arc spraying can be carried out until the gaps in the original glass fibre grid are closed and a compact continuous layer (composite) is formed. This composite is distinguished by a high strength with a low intrinsic weight at the same time. Furthermore, mechanical processing methods such as drilling, milling, grinding, polishing or similar of this composite are possible.

The fibre composite material with metal matrix described forms a highly strong, non-inflammable, non-fragile material without splintering behaviour with an optimal ratio of strength to weight. The matrix materials are not restricted to light metals such as, for example, aluminium, any other suitable metals can be used, which can be applied in a suitable form as a layer to the prepared fibre material. The actual matrix is substantially only formed by this coating and a non-positive connection is produced between fibres and metal matrix.

By using a combination of a galvanic method (directional Faraday process) to produce a metallization, conducting or adhesive layer with a process having a high application rate, in particular thermal spraying, effective cladding of the fibre material at a high application rate is possible. At the same time, one is not restricted to the common metals of the electrochemical potential series as is the case, for example with the galvanic method. As far as the size of the fibre composites which can be produced, i.e. ultimately the components which can be produced, there is virtually no limit since thermal spraying can be carried out with components of almost any size. A particular advantage compared with the PVD/CVD method, for example, is on the one hand that the application rate is substantially higher, that the fibres can be coated from all sides and that there are no limits regarding the size of the components such as exist in the said vacuum methods in which the dimension is limited by the size of the surrounding vacuum vessel.

### REFERENCE LIST

1 Fibres
2 Metallization layer, metal conductive layer
3 Metal adhesive layer
4 Metal final layer
10 Fibre composite material

1-25. (canceled)

26. A fibre composite material having a metal matrix comprising:
a fibre material having individual fibres; and
a metal coating including a metallization layer disposed on the individual fibres so as to surround the fibres and a metal final layer disposed on the metallization layer, wherein the metal coating forms the metal matrix.

27. The fibre composite material as recited in claim 26, wherein a non-positive connection is maintained between the individual fibres and the metal matrix.

28. The fibre composite material as recited in claim 26, further comprising a metal adhesive layer disposed between the metallization layer and the metal final layer.

29. The fibre composite material as recited in claim 26, wherein the metallization layer has a thickness of 0.5 μm to 0.5 mm.

30. The fibre composite material as recited in claim 26, wherein the metal final layer has a thickness of 2 μm to 20 mm.

31. The fibre composite material as recited in claim 26, wherein the metal final layer has a thickness of 20 μm to 2 mm.

32. The fibre composite material as recited in claim 28, wherein the metal adhesive layer has a thickness of 2 μm to 1 mm.

33. The fibre composite material as recited in claim 28, wherein the metal adhesive layer has a thickness of 20 μm to 200 μm.

34. The fibre composite material as recited in claim 26, wherein the individual fibres include at least one of glass, carbon and aramide fibres.

35. The fibre composite material as recited in claim 26, wherein the individual fibres include electrically non-conductive material.

36. The fibre composite material as recited in claim 28, wherein at least one of the metallization layer and the metal adhesive layer include at least one of copper and nickel.

37. The fibre composite material as recited in claim 26, wherein the metal final layer includes a light metal.

38. The fibre composite material as recited in claim 26, wherein the individual fibres are arranged in the form of one of a scrim, a woven fabric, a nonwoven and a braided fabric.

39. The fibre composite material as recited in claim 38, further comprising a metal adhesive layer disposed between the metallization layer and the individual fibres.

40. A method for producing a fibre composite material having a metal matrix comprising:
providing a fibre material having individual fibres; and
surrounding the individual fibres with a metallization layer; and
applying a metal final layer to the metallization layer, the metal final layer and the metallization layer forming a metal matrix.

41. The method as recited in claim 40, further comprising applying a metal adhesive layer between the metallization layer and the metal final layer.

42. The method as recited in claim 40, further comprising applying the metallization layer chemically or by thermal spraying.

43. The method as recited in claim 40, further comprising applying the metal final layer galvanically or by thermal spraying.

44. The method as recited in claim 41, further comprising applying the metal adhesive layer galvanically or by thermal spraying.

45. The method as recited in claim 40, wherein the individual fibres include at least one of glass, carbon and aramide fibres.

46. The method as recited in claim 40, wherein the individual fibres include electrically nonconductive material.

47. The method as recited in claim 41, wherein at least one of the metallization layer and the metal adhesive layer include at least one of copper and nickel.

48. The method as recited in claim 40, wherein the metal final layer includes a light metal.

49. The method as recited in claim 40, wherein the providing of the fibre material includes forming the individual fibres into one of a scrim, a woven fabric and a braided fabric.

50. The method as recited in claim 49, wherein the surrounding the individual fibres includes surrounding the individual fibres with at least one of the metallization layer and a metal adhesive layer.
